(19) United States
(12) Patent Application Publication
(10) Pub. No.: US 2025/0370640 A1
(43) Pub. Date: Dec. 4, 2025

(54) ALLOCATION AREA PROTECTION GROUPS

(71) Applicant: NetApp, Inc., San Jose, CA (US)

(72) Inventors: Richard Parvin Jernigan, Sewickley, PA (US); Tijin George, San Jose, CA (US)

(21) Appl. No.: 19/186,866

(22) Filed: Apr. 23, 2025

Related U.S. Application Data
(60) Provisional application No. 63/654,244, filed on May 31, 2024.

(51) Int. Cl. G06F 3/06

(52) U.S. Cl. CPC G06F 3/0631; G06F 3/0604; G06F 3/0689

(57) ABSTRACT

Techniques are provided for dynamically generating allocation area protection groups for select data sets. A storage environment may include multiple Redundant Array of Independent Disks (RAID) protection groups. A RAID array protects a certain number of storage devices within the RAID array. To provide additional data protection, certain data sets (e.g., files, directories, or other granularity of data or metadata) may be selectively protected utilizing allocation area protection groups. The allocation area protection groups provide additional data loss protection beyond RAID arrays. An allocation area protection group is dynamically constructed for a data set such that the data set is protected for a failure of a RAID array and/or storage shelf.

### RELATED APPLICATIONS

This application claims priority to U.S. Provisional Patent Application, titled “ALLOCATION AREA PROTECTION GROUPS”, filed on May 31, 2024 and accorded Application No.: 63/654,244, which is incorporated herein by reference.

### BACKGROUND

Many storage environments implement data protection techniques to protect data and metadata. In one example, snapshots of a volume may be created as point in time backups of the volume, which can be used to restore the volume. In another example, data of a first node may be redundantly stored at a second node that can take over the serving of data if the first node fails. Some storage environments may implement Redundant Array of Independent Disks (RAID) arrays. A RAID array can protect a certain number of storage devices within that same RAID array. For example, a RAID array may be composed of one or more data disks storing data and one or more disks storing parity corresponding to the data. If a data bearing disk fails, then the remaining data bearing disks and the one or more parity bearing disks are used to reconstruct the data of the failed data bearing disk.

### DESCRIPTION OF THE DRAWINGS

FIGS. 1A-1D are block diagrams illustrating an example of a system for dynamically generating allocation area protection groups for select data sets, in accordance with an embodiment of the present technology.

FIG. 2A is a flow chart illustrating an example method for creating allocation area protection groups, in accordance with an embodiment of the present technology.

FIG. 2B is a flow chart illustrating an example method for storing data based upon whether the data is part of a data set assigned to an allocation area protection group, in accordance with an embodiment of the present technology.

FIG. 2C is a flow chart illustrating an example method of selecting allocation areas to form an allocation area protection group, in accordance with an embodiment of the present technology.

FIG. 3A is a block diagram illustrating an example of RAID protection groups of allocation areas available for forming an allocation area protection group, in accordance with an embodiment of the present technology.

FIG. 3B is a block diagram illustrating an example of a system for storing a data set within an allocation area, in accordance with an embodiment of the present technology.

FIG. 3C is a block diagram illustrating an example of a system for storing a data set within a shelf allocation area protection group, in accordance with an embodiment of the present technology.

FIG. 3D is a block diagram illustrating an example of a system for storing a data set within an allocation area protection group, in accordance with an embodiment of the present technology.

FIG. 4A is a flow chart illustrating an example method for erroring handling, in accordance with an embodiment of the present technology.

FIG. 4B is a block diagram illustrating an example of a system for recovering from a failure of a RAID array, in accordance with an embodiment of the present technology.

FIG. 5 is a block diagram illustrating an example of a system for dynamically generating a new allocation area protection group as part of recovering from a failure of a protection group, in accordance with an embodiment of the present technology.

FIG. 6 is a block diagram illustrating an example of a node in accordance with an embodiment of the present technology.

FIG. 7 is an example of a computer readable medium in which an embodiment of the present technology may be implemented.

### DETAILED DESCRIPTION

Systems and methods are provided for dynamically generating allocation area protection groups for select data sets. Allocation area protection groups provide additional data protection beyond conventional data protection techniques provided by Redundant Array of Independent Disks (RAID). With conventional RAID, a set of disks (or storage devices, used interchangeably throughout the specification) are grouped together as a RAID array. RAID protection typically protects a certain number of disk failures within the same RAID array, and is unable to provide data protection if the entire RAID array fails or if an entire storage shelf containing the set of disks fails. To overcome these technical limitations of conventional RAID and of other data protection techniques, the disclosed technology provides additional data protection that can protect from even an entire RAID array failure or storage shelf failure by using allocation area protection groups.

The disclosed allocation area protection groups of allocation areas provide additional data protection for select data sets that can be protected from an entire RAID array failure, storage shelf failure, and other types of failures. An allocation area, as used herein, is intended to include a contiguous set of stripes within an aggregate that is composed of a collection of disks managed as a single unit of storage. A stripe is a set of blocks that belong to a data disk of a RAID group. There may be one stripe per data disk, and the set of blocks of the stripe share a same parity block on a parity disk. Thus, the allocation area is a group of physical storage blocks used to store data of the RAID group. An allocation area protection group, as used herein, is intended to include a dynamically defined/grouped set of selected allocation areas that form a unit of protection used to protect data within the allocation area protection group. The allocation area protection group may be defined to include allocation areas dynamically selected from different RAID groups, which may be dynamically selected for the aggregate and/or by a consistency point operation that stores data to disks of the RAID groups.

A data set may be selected to include a file, a directory, metadata but not data, a volume, data managed by a particular node, an entire cluster, or any other granularity of data. The data set is tagged with an indicator to indicate that the data set is to be protected by an allocation area protection group. If there is no existing allocation area protection group already created for the data set, then dynamic construction of an allocation area protection group for protecting the data set is performed. When data of the data set is to be transferred from a memory to a persistent storage device, such as by a consistency point, the indicator will trigger the dynamic construction of the allocation area protection group into which the data will be stored if there is no existing allocation area protection group for the data set, otherwise the data will be stored into an existing allocation area protection group based upon the indicator.

As part of constructing the allocation area protection group, allocation areas are selected from RAID arrays of a storage environment (e.g., no more than one allocation area may be selected from a RAID array and/or storage shelf) to form the allocation area protection group. One or more of the allocation areas are selected as parity bearing allocation areas for reconstructing missing data, while other allocation areas are selected as data bearing allocation areas used to store data being protected by the allocation area protection group. Because one allocation area is selected from a RAID array and/or storage shelf, the data set can be protected from a failure of an entire RAID array and/or storage shelf (e.g., an entire RAID array failure such as a disaster affecting an entire storage shelf). For example, if one of the data bearing allocation areas fails (e.g., because of a failure of an entire RAID array hosting the data bearing allocation area), then a parity bearing allocation area and remaining data bearing allocation areas can be used to reconstruct data.

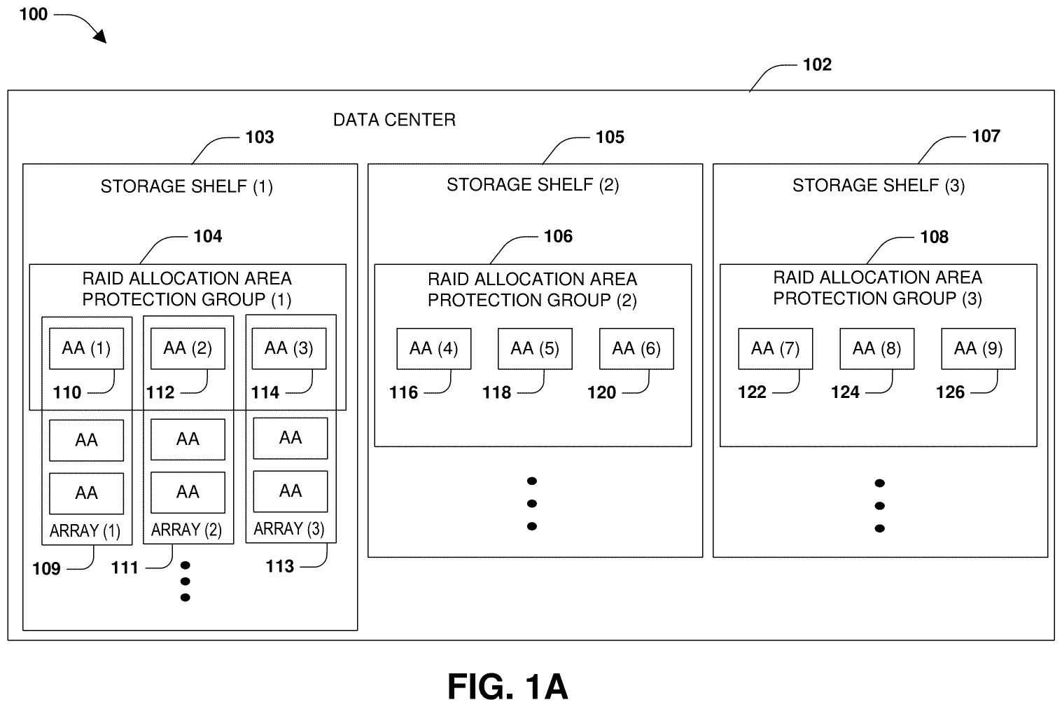

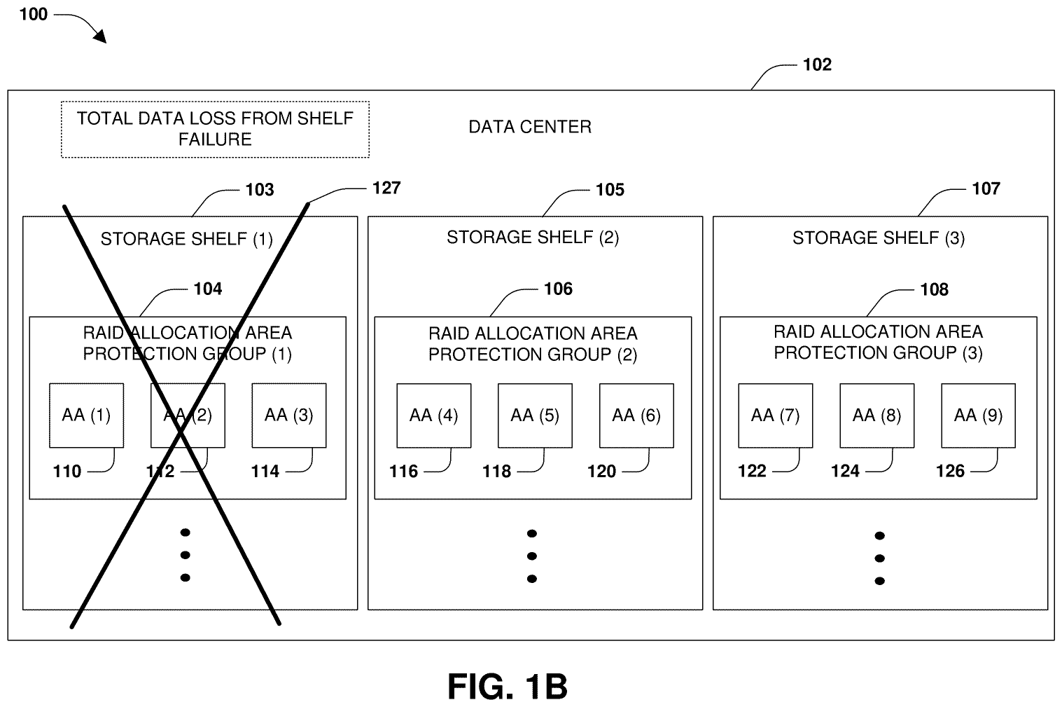

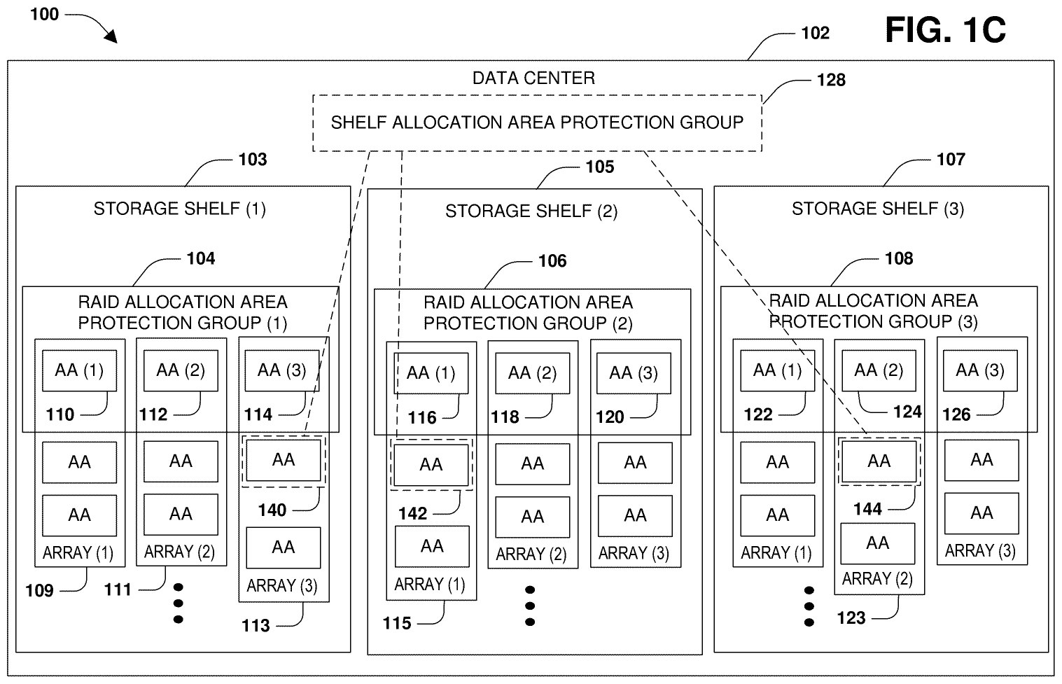

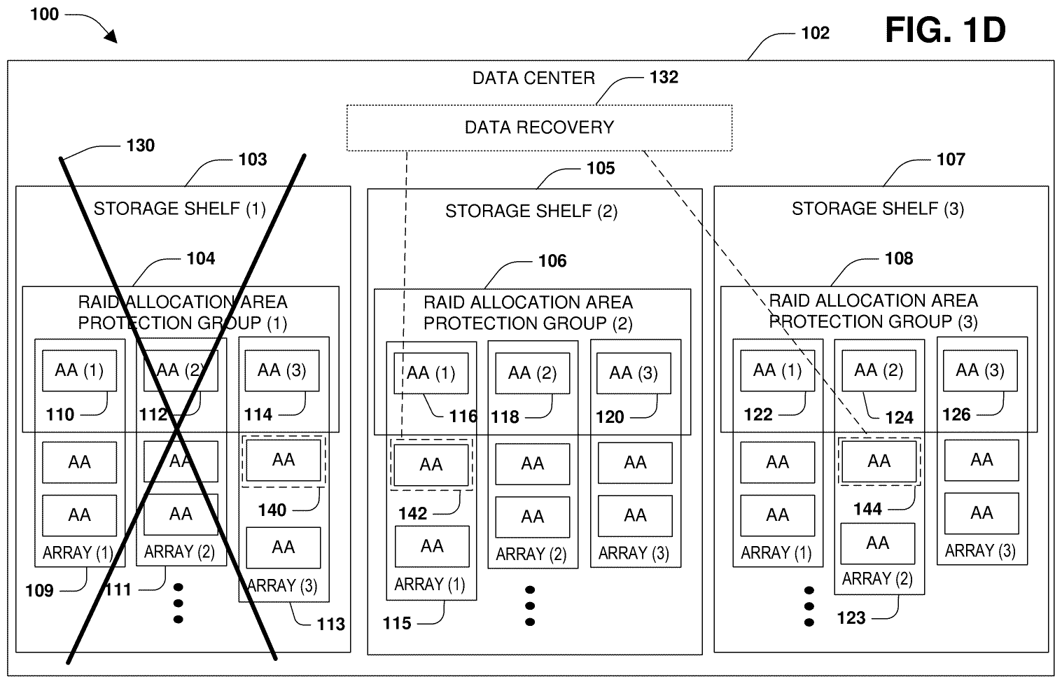

FIGS. 1A-1D are block diagrams illustrating an example of a system 100 for dynamically generating allocation area protection groups for select data sets. A data center (or a storage environment) 102 may include storage shelves (disk shelves) that contain storage devices (e.g., disk drives), such as a first storage shelf 103 of storage devices, a second storage shelf 105 of storage devices, a third storage shelf 107 of storage devices, and/or other storage shelves. A storage shelf may comprise storage devices that are grouped into RAID arrays. For illustration, only in first storage shelf 103 for simplicity, the first storage shelf 103 contains three RAID arrays (1) 109, (2) 111, and (3) 113. Each RAID array 109, 111, 113 includes a series of allocation areas AA. For example, the first storage shelf 103 may contain two or more allocation areas that are grouped into a first RAID protection group 104. The illustrated first RAID protection group 104 is formed from allocation area (1) 110 from RAID array (1) 109, allocation area (2) 112 from RAID array (2) 111, and allocation area (3) 112 from RAID array (3) 113. The second storage shelf 105 may contain two or more allocation areas grouped into a second RAID protection group 106. The third storage shelf 107 may contain two or more allocation areas grouped into a third RAID protection group 108. It may be appreciated that a storage shelf may include any number of RAID protection groups, such as where a disk shelf includes a first set of allocation areas forming the RAID protection group, a second set of allocation areas forming another RAID protection group, etc. Each allocation area in each RAID protection group is on a different RAID array.

Conventional RAID is commonly used to protect a set of storage devices from data loss in the event there is a disk failure. There are many types of RAID arrays that have different RAID levels such as RAID 0 (striping), RAID 1 (mirroring) and its variants, RAID 4 (data drives and a parity drive), RAID 5 (distributed parity), RAID 6 (dual parity), etc. A RAID array may be formed from a set of storage devices (disks). One or more disks may be designated as parity disk(s), and the other disks may be designated as data disks. If there is a disk failure or error with a subset of the data disks, then the parity disk(s) and remaining data disks can be used to reconstruct the missing data affected by the disk failure.

Conventional RAID can be used to protect a subset of disks within a RAID array. However, conventional RAID cannot protect the entire RAID array if there is a failure that affects the entire RAID array. For example, the first RAID array (1) 109 is composed of storage disks physically stored and connected together within the first storage shelf 103. This co-locality makes the entire first RAID array (1) 109 vulnerable to physical-world problems: electrical shocks, chemical ingest into the cooling fans, cold water pipes bursting above the shelf, etc. These types of events can take out entire RAID arrays. Thus, a failure 127 of the entire first storage shelf 103 will result in a total data loss of all RAID protection groups formed from storage devices of the first storage shelf 103, such as the first RAID protection group 104, as illustrated by FIG. 1B. Conventional RAID cannot protect a RAID array if the entire RAID array has failed such as where a storage shelf is damaged, experiences a power loss, or some other issue. That is, entire shelves can fail all at once, and the basic RAID mechanism can be overwhelmed and left unable to do anything meaningful.

Additionally, conventional RAID generally has a maximum effective size. That is, a RAID array can only encompass so many disks (e.g., a few dozen typically) before the RAID array is no longer an effective protection mechanism. Thus, storage environments often employ multiple discrete RAID arrays for storage needs, such as where RAID array A encompasses a first set of 40 disks, then a completely independent RAID array B encompasses a second set of 40 disks, and so on. Any given RAID mechanism (including systems like Erasure Coding) is designed to survive at most N concurrent failures of the underlying storage units (disks). For example, RAID-TEC is designed to survive 3 concurrent disk failures. If 4 disks fail concurrently, then the RAID array is unable to operate and all remaining contents in the group are lost. The “maximum effective size” is a value judgement: if there are 10 disks in the RAID array, then the odds of 4 concurrent failures out of those 10 disks are pretty small. But if there are 1,000 disks in the RAID array, then the odds that 4 will be dead at any given time are substantially higher. At some point, the odds of failure represent too high a risk for a business to accept.

In some embodiments, a storage shelf can have multiple RAID protection groups or a RAID protection group can span multiple storage shelves. The disclosed allocation area protection groups can handle failures of a RAID array, a storage shelf, or both together in any form factor of disk constitution because allocation areas of an allocation area protection group are placed within at least two instances of an object (e.g., an object being a RAID array, a storage shelf, or both together) being protected. In one example, a RAID protection group size is 48 and the shelf size is 24 disks. With the disclosed protection scheme, the protected object is to have a minimum set of 2 instances. So, a storage system will have a minimum of 2 RAID protection groups. For 2 RAID protection groups of 48 disks each, there will be a total of 4 storage shelves. Since the protected allocation areas provide redundancy across RAID protection groups, the disclosed protection scheme can handle the loss of 1 RAID protection group or up to 2 storage shelves. In another example, the RAID protection group size is 12 and the shelf size is 24 disks. With the disclosed protection scheme, the protected object is to have a minimum set of 2 instances. If a storage shelf is the protected object, the storage system is to have 2 storage shelves and 4 RAID protection groups. If shelf-level redundancy is required, then the constituent allocation areas of the allocation area protection group is to be chosen from one RAID protection group in storage shelf 1 and another RAID protection group in storage shelf 2.

The disclosed allocation area protection groups can protect from RAID errors that cause block level corruptions. Because a storage system may utilize a file system that employs a file system tree, the extent of a block corruption can be pervasive with an impact depending upon the level of the block in the file system tree. One example of a RAID error is a media error. When disks in a RAID array fail, RAID performs parity reconstruction to recover a lost disk. Parity reconstruction causes heavy I/O on engaged disks and increases the chance of running into media errors. Another example of a RAID error is lost writes. When RAID writes data to the disks, disk software could return success, but may not write the data to the disk due to firmware bugs or other reasons. When the data is to be read, the data will not be located. These RAID errors can cause data loss. The disclosed allocation area protection groups can handle these RAID errors without data loss because there is redundancy of data within an allocation area protection group that is handled in the file system so any loss of data in one allocation area of the allocation area protection group can be replaced by the redundancy.

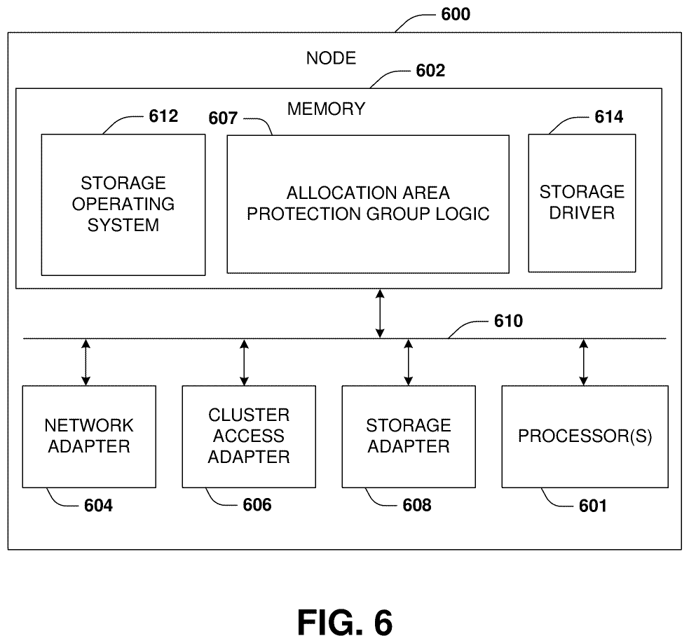

Referring to FIG. 1C, a shelf allocation area protection group 128 may be dynamically constructed for a data set in order to protect the data set beyond what protection is provided by conventional RAID. In some embodiments, the shelf allocation area protection group 128 may be dynamically constructed and managed by allocation area protection group logic (e.g., allocation area protection group logic 607 of FIG. 6). Each RAID protection group may be composed of multiple allocation areas from which blocks can be allocated to store data. A first RAID protection group 104 may include a first allocation area 110 of blocks of storage, a second allocation area 112 of blocks of storage, a third allocation area 114 of blocks of storage, and/or other allocation areas. A second RAID protection group 106 may include a fourth allocation area 116 of blocks of storage, a fifth allocation area 118 of blocks of storage, a sixth allocation area 120 of blocks of storage, and/or other allocation areas. A third RAID protection group 108 may include a seventh allocation area 122 of blocks of storage, an eighth allocation area 124 of blocks of storage, a ninth allocation area 126 of blocks of storage, and/or other allocation areas.

Shelf allocation area protection group 128 is illustrated as being formed by using an allocation area 140 from the RAID array 113 from the first storage shelf 103, an allocation area 142 from the RAID array 115 from the second storage shelf 105, and an allocation area 144 from the RAID array 123 from the third storage shelf 107. By selecting allocation areas from different shelves to form the shelf allocation area protection group 128, a single storage shelf can fail, and the shelf allocation area protection group 128 will not sustain an irrecoverably lose data. In some embodiments, the first storage shelf 103 and the second storage shelf 105 may be different storage shelves in that the first storage shelf 103 and the second storage shelf 105 may be in different locations within the data center 102 (e.g., within different rooms, different buildings, different physical locations within a room, etc.). In some embodiments, the first storage shelf 103 and the second storage shelf 105 may be different storage shelves in that the first storage shelf 103 and the second storage shelf 105 may be part of different storage housing structures (e.g., the first storage shelf 103 may be housed within a different physical storage rack structure than a physical storage rack structure housing the second storage shelf 105). In some embodiments, two storage shelves may be different storage shelves in that the two storage shelves may be located physically separate from one another (e.g., the two storage shelves are located in different data centers).

It is noted that different allocation areas 114 and 140 in the RAID array 113 are used to form the first RAID protection group 104 and the shelf allocation area protection group 128. In some embodiments, an allocation area is selected to be part of a single allocation area protection group. It may be appreciated that there may be any number of RAID and shelf protection groups, a RAID or shelf protection group can include any number of allocation areas, and an allocation area protection group employs two or more allocation areas selected from different RAID protection groups and/or storage shelves (e.g., one allocation area may be selected from a single RAID protection group and/or storage shelf).

The allocation area protection group logic may identify a data set that is to be protected by an allocation area protection group. In some embodiments, the data set may be selected for protection such as by an administrator of the data center. The data set may include a file, a directory, metadata but not data, a volume, data managed by a particular node, an entire cluster, or any other granularity of data. The allocation area protection group logic may tag the data set with an indicator to indicate that the data set is to be protected by an allocation area protection group. If there is no existing allocation area protection group already created for the data set, then a shelf allocation area protection group 128 is dynamically constructed for protecting the data set. Before being stored to the allocation area protection group, the data may be first stored within a memory before being subsequently transferred to storage devices of the RAID array.

When data is to be stored from the memory to the storage, the data is evaluated to determine whether the data is part of a data set that is tagged with an indicator, such as data to store within a directory tagged with the indicator. If data is part of a data set not tagged with the indicator tag, then the data can be written to storage using allocation areas that are not part of an allocation area protection group, thereby avoiding any additional storage costs incurred by utilization of allocation area protection groups. In response to determining that the data is part of a data set tagged with the indicator and there is no existing allocation area protection group, on-demand dynamic creation of the shelf allocation area protection group 128 is triggered, otherwise, the data is stored into the existing allocation area protection group. As part of the on-demand dynamic construction, a plurality of allocation areas are selected from certain storage shelves and/or RAID arrays by the allocation area protection group logic. In some embodiments, one allocation area (or some other number) is selected from a single RAID array. In some embodiments, one allocation area (or some other number) can be selected from a single storage shelf. In some embodiments, one RAID array (or some other number) can be selected from a single storage shelf. In some embodiments, at least two allocation areas are selected. In some embodiments, allocation areas are selected from at least two different shelves (or some other number). In some embodiments, RAID arrays are selected from at least two different shelves (or some other number).

It may be appreciated that the allocation area protection group logic may select allocation areas from all or less than all available RAID arrays. One or more of the allocation areas may be selected as parity bearing allocation area(s), while remaining allocation areas are selected as data bearing allocation areas. In this way, data of the data set will be stored into blocks allocated from the data bearing allocation areas of the shelf allocation area protection group 128 and the parity bearing allocation area(s) will be updated with parity information.

An allocation area ownership map (or a data structure) is populated with information describing what allocation areas have been dynamically grouped together as the allocation area protection group (e.g., allocation area ownership map 352). In some embodiments, the allocation area ownership map may be populated with an entry mapping the shelf allocation area protection group 128, the data set (e.g., an indicator/name of a file, a directory, a volume, a node, a cluster, aggregate, or any other data set), an indicator of the allocation area 140 on the RAID array 113 in the first storage shelf 103, an indicator of the allocation area 142 on the RAID array 115 in the second storage shelf 105, and an indicator of the allocation area 144 on the RAID array 123 in the third storage shelf 107 together. Similarly, the allocation area ownership map may be populated with any entry for mapping the first RAID protection group 104, the data set, an indicator of the first allocation area 110 on the RAID array 109, an indicator of the second allocation area 112 on the RAID array 111, and an indicator of the third allocation area 114 on the RAID array 113, all in the first storage shelf 103, together. The allocation area ownership map may identify storage selves from which the allocation areas are selected. The allocation area ownership map may identify which allocation areas are data bearing. The allocation area ownership map may identify which allocation area(s) are parity bearing (e.g., an allocation area may be used for RAID 4, while multiple allocation areas may be used for rotated parity of RAID 5).

In some embodiments, the allocation area ownership map is a metafile that outlines which allocation areas are currently owned by which aggregates or other types of data sets. An aggregate is a collection of disks locally grouped together that provide storage to one or more volumes contained by the aggregate, and thus the aggregate owns allocation areas of those disks. When data of the data set is to be written to storage or read, the allocation area ownership map can be used to locate the data. For example, if the storage is operating in a degraded mode because of a failure, then the allocation area ownership map can be used to perform degraded reads that are directed to surviving operational data bearing allocation areas of the allocation area protection group and the parity bearing allocation area of the allocation area protection group, and the parity bearing allocation area of the allocation area protection group is used for reconstructing data contained on the non-operational data bearing allocation area.

If there is a failure 130 of the first storage shelf 103, then the disclosed technology can utilize the shelf allocation area protection group 128 to perform data recovery 132, as illustrated by FIG. 1D. In particular, the failure 130 of the first storage shelf 103 may result in a loss of the RAID array 113 that includes the allocation area 140. Accordingly, the data recovery 132 is performed using the allocation area 142 of the RAID array 115 contained within the second storage shelf 105 and/or the allocation area 144 of the RAID array 123 contained within the third storage shelf 107.

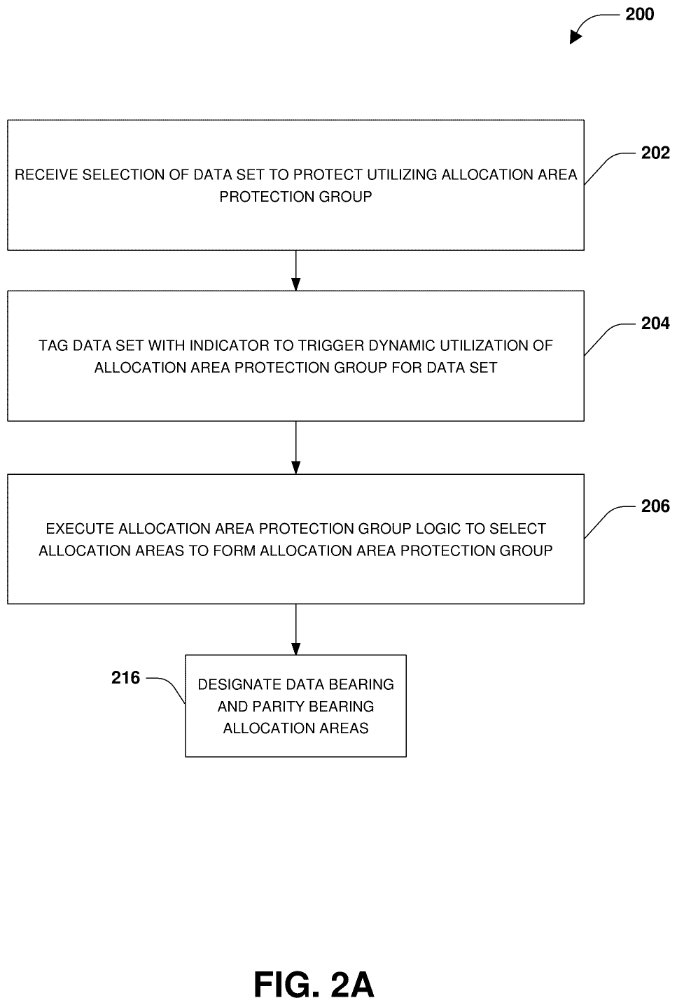

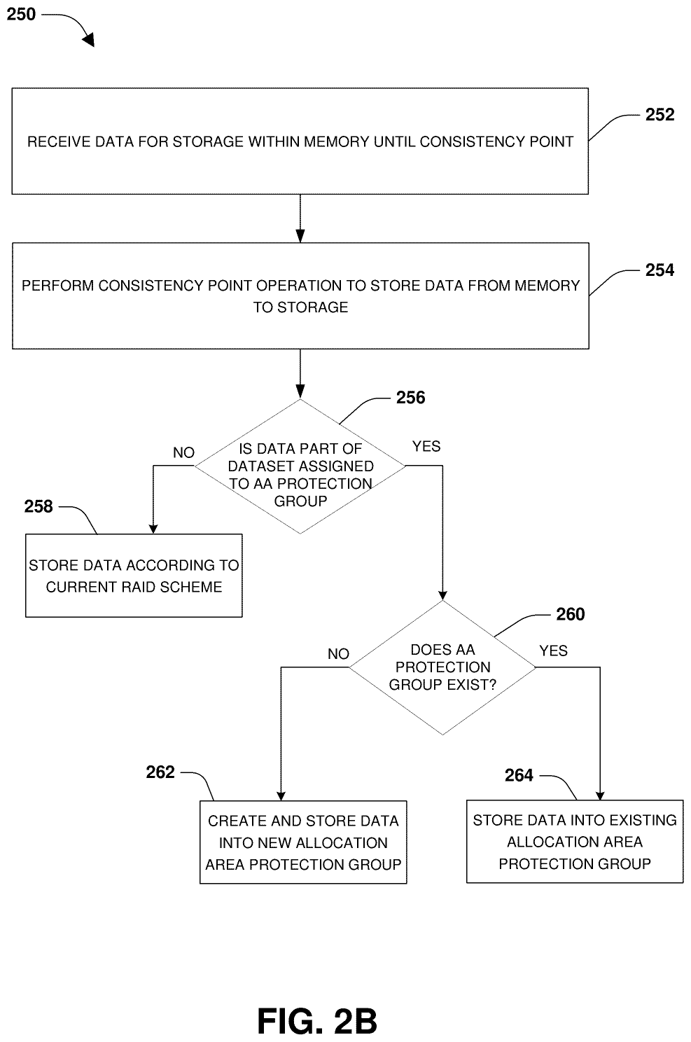

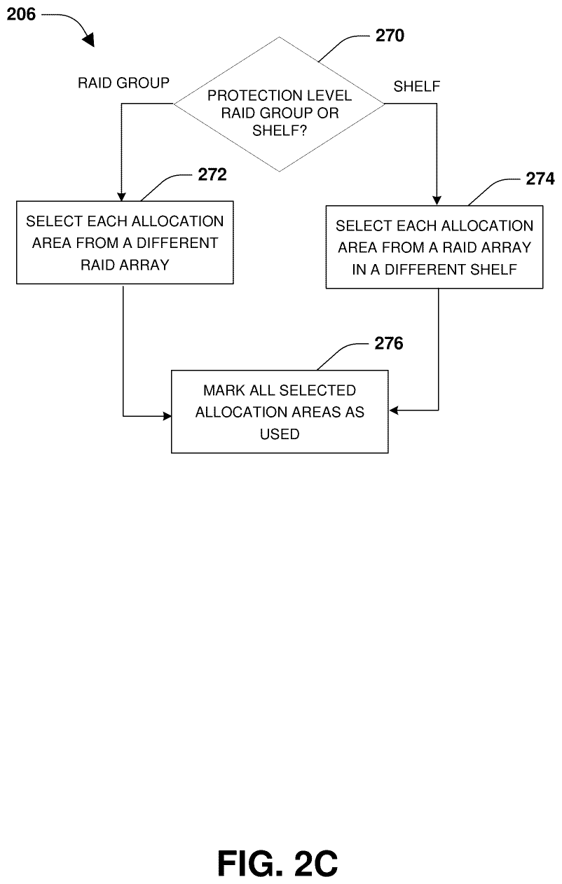

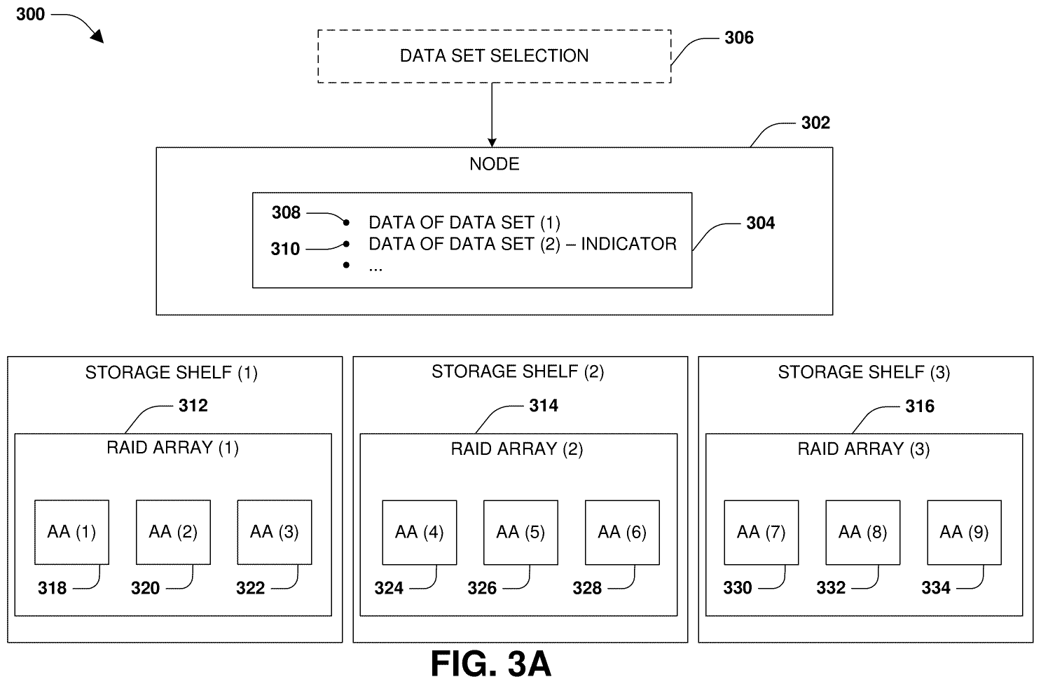

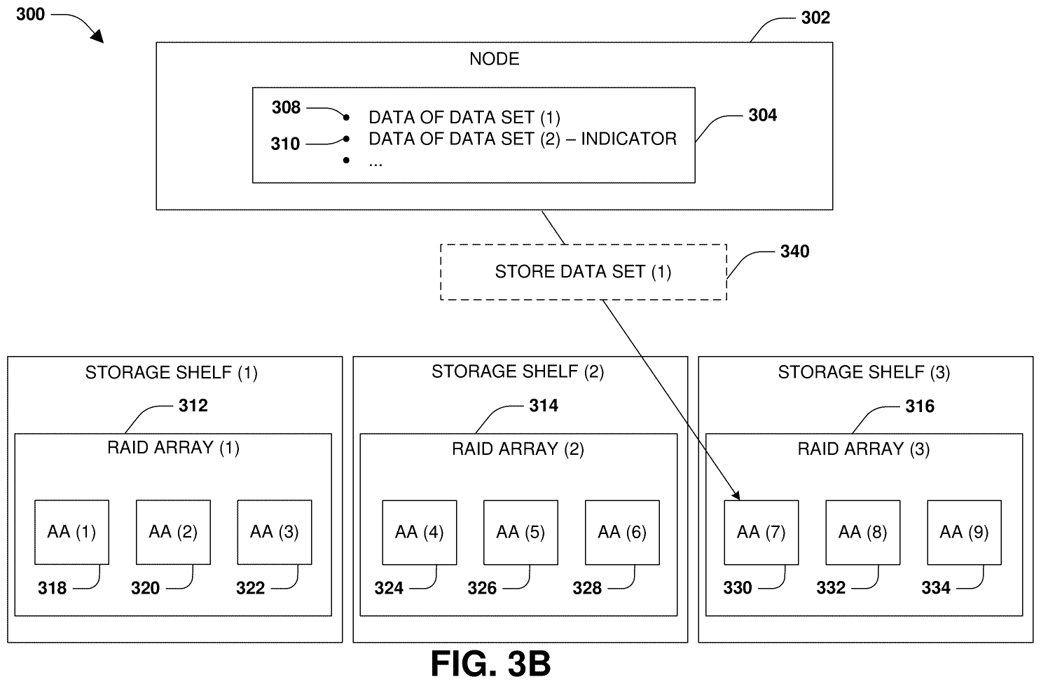

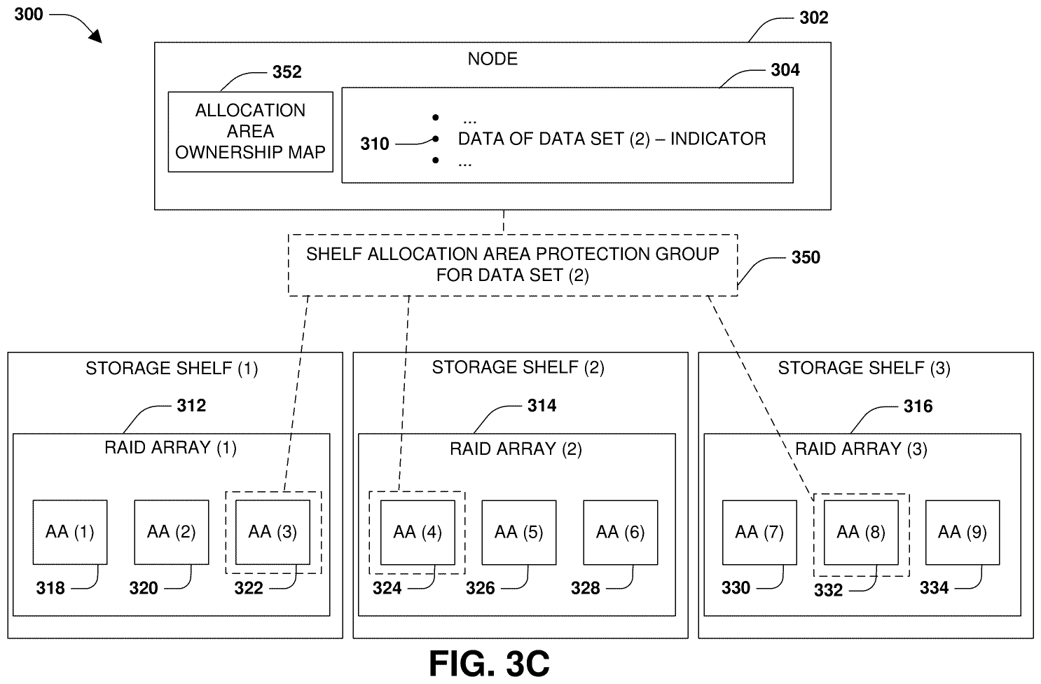

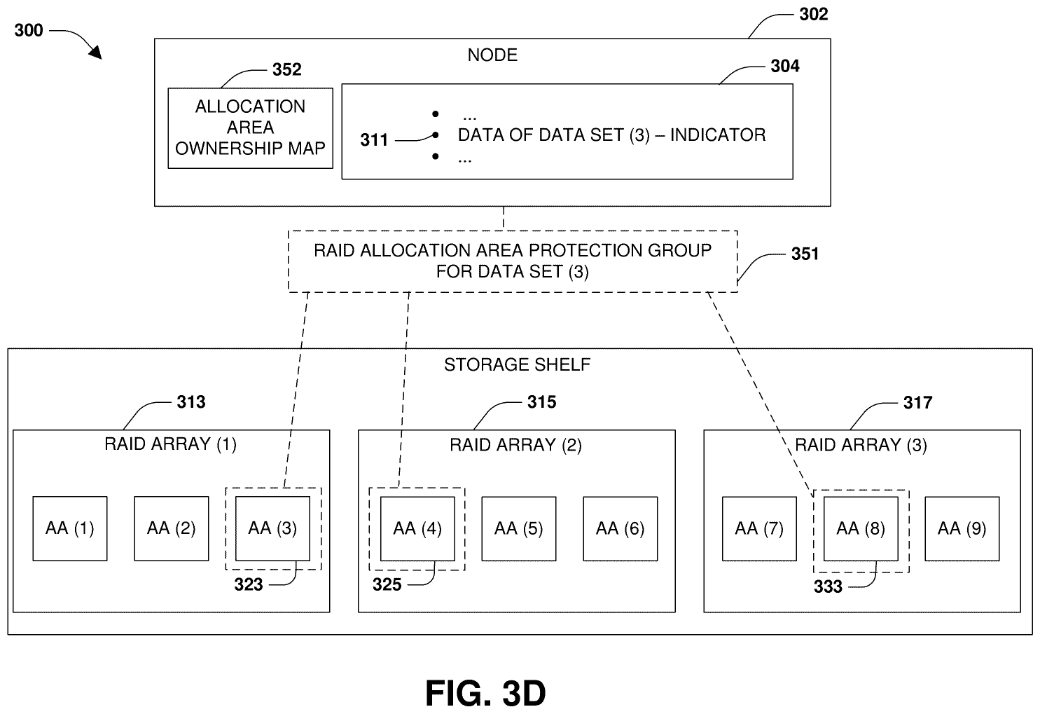

FIG. 2A is a flow chart illustrating an example method 200 for creating one or more allocation area protection groups. During operation 202 of method 200, a node 302 may receive a selection 306 of a data set to protect using allocation area protection groups, as illustrated by FIG. 3A. For example, the selection 306 may specify that a second data set 310 (e.g., a particular file, directory, volume, data owned by a node, metadata but not data, data of a cluster, etc.) is to be protected using allocation area protection groups. In some embodiments, the protection provided by the allocation area protection groups is in addition to any existing protection such as conventional RAID schemes. Accordingly, during operation 204 of method 200, the second data set 310 is tagged with an indicator that will trigger dynamic construction of an allocation area protection group for the second data set 310 if there is not already an existing allocation area protection group for the second data set 310. In some embodiments, the indicator (e.g., a flag) provides an indication that a subsequent operation such as a consistency point operation will implement allocation area protection group logic for data that is to be stored within the second data set 310 (e.g., data, to be stored within a volume tagged with the indicator, will be stored into an allocation area protection group for that volume). The data of the second data set 310 may be currently stored within memory 304. The memory 304 may also store data of other data sets that are or are not tagged with indicators that would otherwise trigger the dynamic construction of allocation area protection groups for those data sets. For example, the memory 304 may store a first data set 308 that is not tagged with the indicator, and thus the first data set 308 will not be protected using allocation area protection groups (e.g., the first data set 308 may be protected using conventional RAID protection).

During operation 206 of method 200, allocation area protection group logic is executed to select allocation areas to form a shelf allocation area protection group 350 for the second data set 310. The shelf allocation area protection group 350 may be dynamically constructed by selecting a plurality of allocation areas from different RAID arrays and/or across different storage shelves as the shelf allocation area protection group 350 using various selection criteria. A plurality of allocation areas is selected by the allocation area protection group logic from available RAID protection groups such that one allocation area is selected from a single RAID array. The allocation area protection group logic may select allocation areas such that one allocation area is selected from a single storage shelf. The allocation area protection group logic may select allocation areas such that at least two allocation areas are to be selected, which are selected from different RAID protection groups (different RAID protection groups) and/or different storage shelves.

Operation 206 is illustrated in more detail in FIG. 2C. In operation 270, it is determined if the data set is to use RAID group level protection or shelf level protection. If RAID group level protection, in operation 272 each allocation area is selected from a different RAID array. As shelf level protection is not selected, the selected locations can be in a single shelf or can be spread among different shelves. If shelf level protection is indicated, in operation 274 each allocation area is selected from one RAID array in a different shelf. Shelf level protection thus also provides RAID protection group level protection as each selected area is also in a different RAID array. After operations 272 and 274, all selected allocation areas are marked as used so that the allocations areas are not reused, during operation 276.

When all of the allocation areas have been selected, then one or more selected allocation areas are defined as data bearing allocation areas and/or one or more select allocation areas are defined as parity bearing allocation areas, during operation 216 of method 200. In this way, the shelf allocation area protection group 350 is dynamically created with parity and data bearing allocation areas selected from different RAID arrays and/or storage shelves.

In some embodiments, an efficiency metric or consideration is taken into account when selecting how many allocation areas to use as the shelf allocation area protection group 350. A minimum of 2 RAID arrays is defined as a consideration. With 2 RAID arrays, the cost of parity for allocation area protection groups is 50% (e.g., 1 data copy and 1 parity copy). When more RAID arrays are utilized, the efficiency increases (e.g., with 5 RAID arrays, the cost of parity to data is 20%, and with 10 RAID arrays, the cost of parity to data is 10%). This is beneficial because distributed systems are expected to grow, and efficiencies will improve with size. The more RAID arrays, the higher the efficiency. Thus, this mechanism allows an administrator to easily and flexibly select what content should and should not be protected by allocation area protection groups such as where merely certain data is selected for protection. The efficiency metric may be selected by the administrator or may be selected based upon storage resource availability and topology.

In some embodiments, the allocation area protection group logic may select the third allocation area 322 from the first RAID array 312, the fourth allocation area 324 from the second RAID array 314, and the eighth allocation area 332 from the third RAID array 316, as illustrated by FIG. 3C to form a shelf allocation area protection group 350, as each allocation area is selected from a different storage shelf.

In some embodiments, the allocation area protection group logic may select the third allocation area 323 from the first RAID array 313, the fourth allocation area 325 from the second RAID array 315, and the third allocation area 333 from the third RAID array 317, as illustrated by FIG. 3D to form a RAID allocation area protection group 351 for a third data set 311, as each allocation area is selected from a different RAID array but all within a single storage shelf.

It may be appreciated that the allocation area protection group logic may select allocation areas from all or less than all available RAID protection groups and/or storage shelves. One or more of the allocation areas may be selected as a parity bearing allocation area, while remaining allocation areas are selected as data bearing allocation areas. In this way, data of the second data set 310 will be stored into blocks allocated from the data bearing allocation areas of the shelf allocation area protection group 350 and the parity bearing allocation area will be updated with parity information.

In some embodiments, an allocation area ownership map 352 is populated to specify which allocation areas have been dynamically selected by the allocation area protection group logic to form the shelf allocation area protection group 350 for the second data set 310. The allocation area ownership map 352 may specify that the third allocation area 322, the fourth allocation area 324, and the eighth allocation area 332 have been selected to form the shelf allocation area protection group 350 for the second data set 310. The allocation area ownership map 352 may specify which allocation areas are parity bearing allocation areas. The allocation area ownership map 352 may specify which allocation areas are data bearing allocation areas. The allocation area ownership map 352 may be redundantly stored such as on at least two different RAID protection groups and/or on different storage shelves. Thus, if one of the RAID protection groups or storage shelves fails, then the most up-to-date allocation area ownership map 352 will still be available at the other RAID protection group(s).

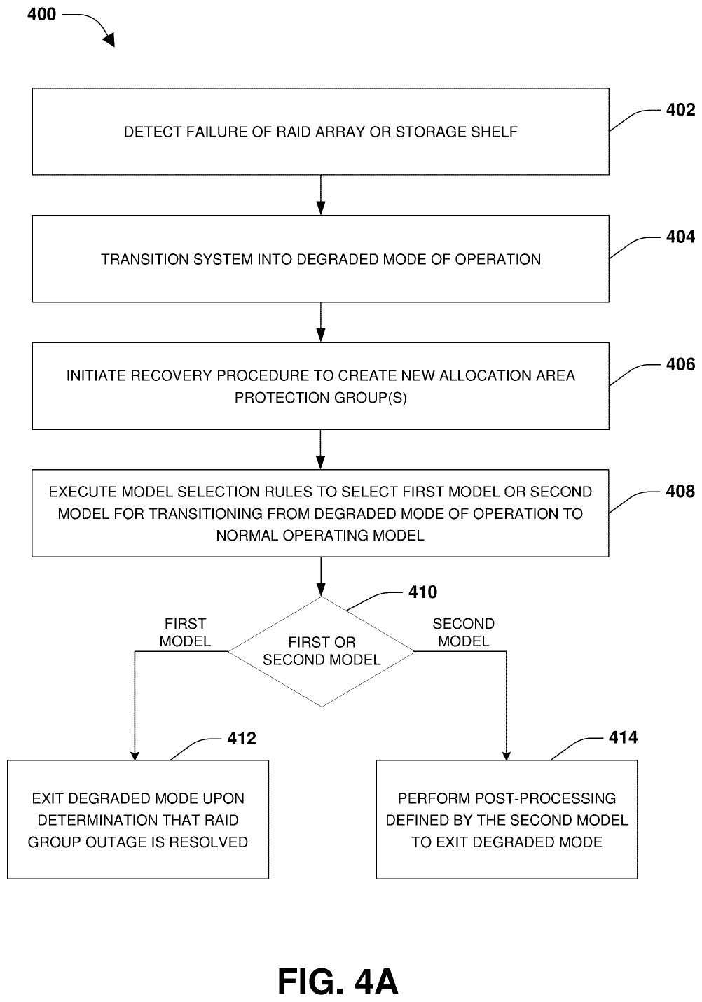

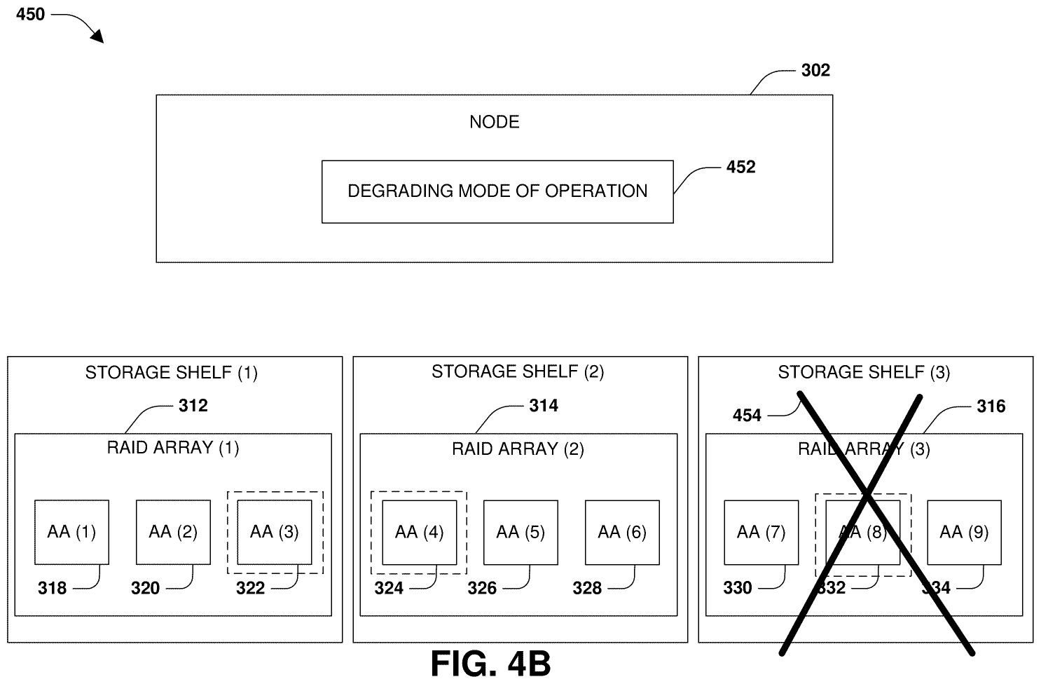

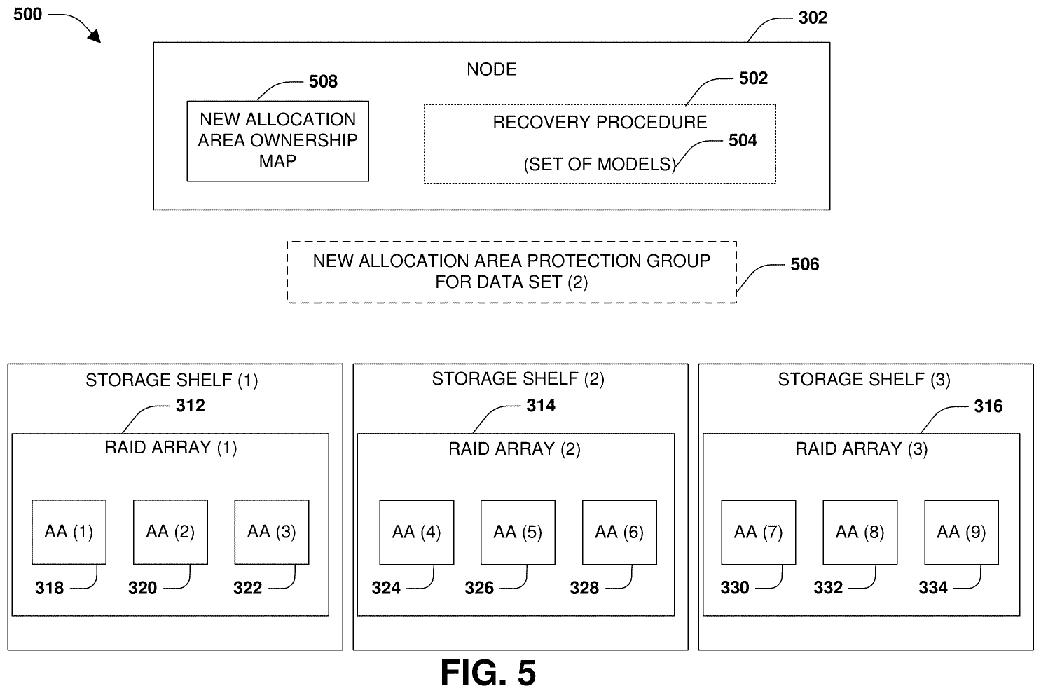

FIG. 2B is a flow chart illustrating an example method 250 for storing data based upon whether the data is part of a data set assigned to an allocation area protection group, which is described in conjunction with system 300 of FIGS. 3A-3D, system 450 of FIG. 4B, and/or system 500 of FIG. 5. In some embodiments, the method 250 may be performed by allocation area protection group logic that may be implemented by the system 300, the system 450, the system 500, and/or the node 600. A node 302 may comprise memory 304 within which data is stored before being written to storage, as illustrated by FIG. 3A. The storage may be composed of storage devices arranged into RAID arrays (e.g., disks arranged into RAID arrays). The first RAID array 312 includes the first allocation area 318, the second allocation area 320, and the third allocation area 322. The second RAID array 314 includes the fourth allocation area 324, the fifth allocation area 326, and the sixth allocation area 328. The third RAID array 316 includes the seventh allocation area 330, the eighth allocation area 332, and the ninth allocation area 334. It may be appreciated that there may be any number of RAID protection groups, and a RAID protection group can include any number of allocation areas. The RAID protection groups may be stored across storage devices of storage shelves (e.g., each RAID protection group may be contained within storage devices of a particular storage shelf). Allocation area protection groups may be constructed from the allocation areas such that an allocation area protection group utilizes allocation areas that span multiple RAID arrays and/or storage shelves, as previously described in relation to method 200 of FIG. 2A.

During operation 252 of method 250, the node 302 receives a write request to write data to the storage. The data is temporarily written into memory 304 until a consistency point operation is triggered to transfer data currently residing in the memory 304 to the storage. Because the data can be written into the memory 304 quicker than the storage, the write request can be quickly acknowledged as complete. At a subsequent point in time, the consistency point operation may be performed to transfer data currently residing in the memory 304 to the storage, during operation 254 of method 250. In some embodiments, the consistency point operation allocates new blocks from the RAID arrays to store data currently residing in the memory 304.

During operation 256 of method 250, the data currently residing within the memory 304 (e.g., the data of the write request) is evaluated to determine whether the data is part of a dataset tagged with an indicator (a flag) indicating that the data set is protected using an allocation area protection group. If the data is part of a data set not tagged with an indicator indicating that the data set is protected using an allocation area protection group (e.g., data is being written to a file, directory, or volume not tagged with the indicator), then the data is stored to the storage without additional protection using allocation area protection groups, during operation 258 of method 250. In some embodiments where a particular RAID scheme (e.g., RAID 4, RAID 5, etc.) has been implemented, the data is stored to storage according to the RAID scheme. In some embodiments where the data is part of the first data set 308 not tagged with the indicator, the data of the first data set 308 is stored 340 from the memory 304 into an allocation area that is not part of an allocation area protection group. For example, the data of the first data set 308 may be stored 340 into the seventh allocation area 330 of the third RAID array 316 according to the RAID scheme, as illustrated by FIG. 3B.

If the data is part of a data set tagged with an indicator indicating that the data set is protected using an allocation area protection group (e.g., a file, a volume, a directory, or other data set tagged with the indicator), then a determination is made as to whether the allocation area protection group already exists or is to be created, during operation 260 of method 250. In some embodiments, the determination is made by evaluating the allocation area ownership map 352 to determine whether there is an existing allocation area protection group for the data set. If there is an existing allocation area protection group for the data set, then the data is stored into the existing allocation area protection group, during operation 264 of method 250. In some embodiments of storing the data into the existing allocation area protection group, new blocks are allocated from data bearing allocation area of the existing allocation area protection group. The data within the memory 304 is then transferred into the new blocks. A parity bearing allocation area of the existing allocation area protection group is updated based upon the data being stored within the new blocks.

In some embodiments where the data is part of the second data set 310 tagged with the indicator, the allocation area ownership map 352 is evaluated to determine that a shelf allocation area protection group 350 exists for the second data set 310, as illustrated by FIG. 3C. The shelf allocation area protection group 350 includes the third allocation area 322 of the first RAID array 312, the fourth allocation area 324 of the second RAID array 314, and the eighth allocation area 332 of the third RAID array 316. In some embodiments, the shelf allocation area protection group 350 may be stored across multiple storage shelves to protect against data loss from an entire storage shelf failure. In this way, the data of the second data set 310 is stored across the allocation areas of the shelf allocation area protection group 350 for the second data set 310.

If there is no existing allocation area protection group for the data set, then a new allocation area protection group is created and the data is stored into the new allocation area protection group, during operation 262 of method 250. It may be appreciated that the new allocation area protection group may be created by the previously described method 200 of FIG. 2A.

FIG. 4A illustrates an example of a method 400 for error handling, which is described in conjunction with system 450 of FIG. 4B and system 500 of FIG. 5. During operation 402 of method 400, the node 302 may detect a failure that affects operation of a RAID protection group such as detection of a storage shelf or RAID array failure, as illustrated by FIG. 4B. For example, the node 302 may detect that the third RAID array 316 has failed 454. Accordingly, during operation 404 of method 400, the node 302 transitions to operating in a degraded mode 452 of operation with respect to the third RAID array 316 and allocation area protection groups whose allocation areas are within the third RAID array 316. If a parity bearing allocation area of an allocation area protection group was stored within an allocation area of the third RAID array 316, then read operations can be processed as normal because the data bearing allocation areas in other RAID arrays are still available. If a data bearing allocation area of the allocation area protection group was part of the third RAID array 316, then degraded read operations are performed for the data set being protected by the allocation area protection group. As part of performing a degraded read operation to read unavailable data stored within an allocation area of the third RAID array 316 that has failed 454, the degraded read operation is directed to surviving operational data bearing allocation areas of the allocation area protection group and the parity bearing allocation area of the allocation area protection group. The parity bearing allocation area of the allocation area protection group is used for reconstructing data contained on the non-operational data bearing allocation area. The parity bearing allocation area may also be used to reconstruct metadata that is detected as being corrupt.

During operation 406 of method 400, a recovery procedure 502 is implemented as part of recovering the third RAID array 316, as illustrated by FIG. 5. The recovery procedure 502 may be performed to build new allocation area protection group(s) to replace the allocation area protection group(s) whose allocation area was part of the third RAID array 316 that failed. The recovery procedure 502 is executed to create the new allocation area protection group(s) such as a new shelf allocation area protection group 506 for the second data set 310. In this way, the shelf allocation area protection group 350 is deconstructed and the new shelf allocation area protection group 506 is constructed. A new allocation area ownership map 508 is created to map blocks of the old allocation area ownership map 352 to blocks of the new allocation area ownership map 508 (e.g., an allocation area ownership map may map blocks of data to particular allocation area protection groups or vice versa). This is because the remaining data of the allocation area protection group is still stored in the same allocation areas of other non-failed RAID protection groups.

A model may be selected from a set of models 504 to determine how to transition from the degraded mode to a normal operating mode. During operation 408 of method 400, model selection rules (e.g., constraints) are executed to select a particular model from the set of models 504 for performing the recovery procedure 502. During operation 410 of method 400, a determination is made as to whether a first model or a second model (or other model) is selected by the model selection rules. The first model may be used to directly exit from the degraded mode to the normal operating mode. The second model may be used to determine what post processing is to be performed for the storage before exiting from the degraded mode.

During operation 412 of method 400, the first model may be used to exit from the degraded mode to the normal operating mode. In particular, the first model may be used where a RAID outage is transient and the missing RAID array (the third RAID array 316) is predicted to reappear for normal operation shortly, so the first model is used to exit the degraded mode quickly with no additional post-processing. To be able to utilize the first model and generally allow the regular use of all existing allocation area protection groups and construction of new allocation area protection groups, the set of model selection rules (e.g., 3 constraints) must be met. A first constraint indicates that write allocations from a missing data bearing allocation area of an existing allocation area protection groups are not allowed. A second constraint indicates that write allocation, even from any healthy data bearing allocation area of an existing allocation area protection group, is not allowed when the parity bearing allocation area of the allocation area protection groups is not available. A third constraint indicates that while this first model (operating model) does allow construction of new allocation area protection groups while in the degraded mode, those new allocation area protection groups must not include allocation areas from the missing RAID array (the third RAID array 316). If the node 302 can remain in this first model throughout degraded mode, then when the RAID array outage is resolved such that when the storage reappears, the degraded mode is exited and normal operation can be resumed without any post-processing. This is because the three constraints will prevent modifications to a file system during the degraded mode that would otherwise require parity reconstruction afterwards.

During operation 414, the second model may be used to determine what post processing is to be performed for the storage before exiting from the degraded mode (e.g., the second model may be used if the 3 constraints for using the first model cannot all be satisfied). The second model utilizes an explicit tagging mechanism to tag particular allocation area protection groups as needing certain classes of recovery after a RAID array outage is complete. The particular classes of post-outage repair stem directly from violations of the three constraints listed above. With the second model, when working with allocation area protection groups that have a data bearing allocation area that is unavailable, write allocations are allowed from that unavailable allocation area, which would violate the first constraint of the first mode. This is accomplished by not writing the new blocks to the unavailable data bearing allocation area itself that is inaccessible, but instead by changing the parity block to ensure that any degraded read of the missing block would synthesize the desired data. However, if the failed RAID array was to reappear afterwards, then there would be an inconsistency: the on-disk data that just reappeared, no longer matches what is to be in the allocation area. Therefore, the second model is used to explicitly mark this unavailable data bearing allocation area as needing to be rebuilt from parity as post-processing even if the original storage becomes directly accessible again.

With using the second model, block allocation is allowed from any data bearing allocation area in allocation area protection group whose parity bearing allocation area is missing, which would violate the second constraint of the first model. The result is that the missing parity data is now incorrect, and if the failed RAID array (the third RAID array 316) were to reappear, then that parity data will need to be reconstructed as post-processing.

With using the second model, a new allocation area protection group that includes an allocation area from the failed RAID array is allowed to be built, which would violate the third constraint of the first model. If this occurs, then the new allocation area protection group will assign that missing allocation area a parity role and will mark that particular allocation area to be reconstructed even if the RAID array returns.

If the RAID array returns after an outage where the second model was used, then some allocation areas will need to be reconstructed. That can be accomplished on first access of an affected allocation area with a scanner to walk all allocation areas in a background to ensure that the storage returns to a healthy state as quickly as possible. In this way, post-processing is performed if the second model is utilized.

The disclosed technology improves upon conventional data loss protection techniques such as RAID by protecting against entire RAID array failure and storage shelf failures that conventional RAID cannot protect against. This enhanced data loss protection is provided through the implementation of allocation area protection groups. An allocation area protection group is defined to include allocation areas from different RAID arrays and/or different storage shelves so that data of the allocation area protection group can be recovered even if an entire RAID array or storage shelf fails.

The disclosed technology provides a recovery procedure that can safely transition the storage system from a degraded mode of operation to a normal operating mode without causing data loss or data inconsistencies. Model selection rules are used to select a model from a set of available models for implementing the recovery procedure. A first model may be used to directly exit from the degraded mode to the normal operating mode based upon certain constraints being met, which provides for a quick and efficient return to normal operations. A second model may be used to determine what post processing is to be performed for storage before exiting from the degraded mode to ensure there is no data loss and/or data inconsistencies. In this way, the disclosed technology improves upon conventional RAID by implementing allocation area protection groups that provide additional data protection and recovery beyond conventional RAID.

Referring to FIG. 6, a node 600 (also referred to as a storage node) in this example includes processor(s) 601, a memory 602, a network adapter 604, a cluster access adapter 606, and a storage adapter 608 interconnected by a system bus 610. In other examples, the node 600 comprises a virtual machine, such as a virtual storage machine.

The node 600 also includes a storage operating system 612 installed in the memory 602 that can, for example, implement a redundant array of inexpensive disks (RAID) data loss protection and recovery scheme to optimize reconstruction of data of a failed disk or drive in an array, along with other functionality such as deduplication, compression, snapshot creation, data mirroring, synchronous replication, asynchronous replication, encryption, etc.

The network adapter 604 in this example includes the mechanical, electrical and signaling circuitry needed to connect the node 600 to one or more of the client devices over network connections, which may comprise, among other things, a point-to-point connection or a shared medium, such as a local area network. In some examples, the network adapter 604 further communicates (e.g., using Transmission Control Protocol/Internet Protocol (TCP/IP)) via a cluster fabric and/or another network (e.g., a WAN (Wide Area Network)) (not shown) with storage devices of a distributed storage system to process storage operations associated with data stored thereon.

The storage adapter 608 cooperates with the storage operating system 612 executing on the node 600 to access information requested by one of the client devices (e.g., to access data on a data storage device managed by a network storage controller). The information may be stored on any type of attached array of writeable media such as magnetic disk drives, flash memory, and/or any other similar media adapted to store information.

In exemplary data storage devices, information can be stored in data blocks on disks. The storage adapter 608 can include I/O interface circuitry that couples to the disks over an I/O interconnect arrangement, such as a storage area network (SAN) protocol (e.g., Small Computer System Interface (SCSI), Internet SCSI (ISCSI), hyperSCSI, Fiber Channel Protocol (FCP)). The information is retrieved by the storage adapter 608 and, if necessary, processed by the processor(s) 601 (or the storage adapter 608 itself) prior to being forwarded over the system bus 610 to the network adapter 604 (and/or the cluster access adapter 606 if sending to another node computing device in the cluster) where the information is formatted into a data packet and returned to a requesting one of the client devices and/or sent to another node computing device attached via a cluster fabric. In some examples, a storage driver 614 in the memory 602 interfaces with the storage adapter to facilitate interactions with the data storage devices.

The storage operating system 612 can also manage communications for the node 600 among other devices that may be in a clustered network, such as attached to the cluster fabric. Thus, the node 600 can respond to client device requests to manage data on one of the data storage devices or storage devices of the distributed storage system in accordance with the client device requests.

The node 600 may implement allocation area protection group logic 607 configured to perform the techniques described herein such as in relation to FIGS. 1-5. For example, the allocation area protection group logic 607 may be configured to dynamically group allocation area protection groups for data sets.

In the example node 600, memory 602 can include storage locations that are addressable by the processor(s) 601 and adapters 604, 606, and 608 for storing related software application code and data structures. The processor(s) 601 and adapters 604, 606, and 608 may, for example, include processing elements and/or logic circuitry configured to execute the software code and manipulate the data structures.

The storage operating system 612, portions of which are typically resident in the memory 602 and executed by the processor(s) 601, invokes storage operations in support of a file service implemented by the node 600. Other processing and memory mechanisms, including various computer readable media, may be used for storing and/or executing application instructions pertaining to the techniques described and illustrated herein.

The examples of the technology described and illustrated herein may be embodied as one or more non-transitory computer or machine readable media, such as the memory 602, having machine or processor-executable instructions stored thereon for one or more aspects of the present technology, which when executed by processor(s), such as processor(s) 601, cause the processor(s) to carry out the steps necessary to implement the methods of this technology, as described and illustrated with the examples herein. In some examples, the executable instructions are configured to perform one or more steps of a method described and illustrated later.

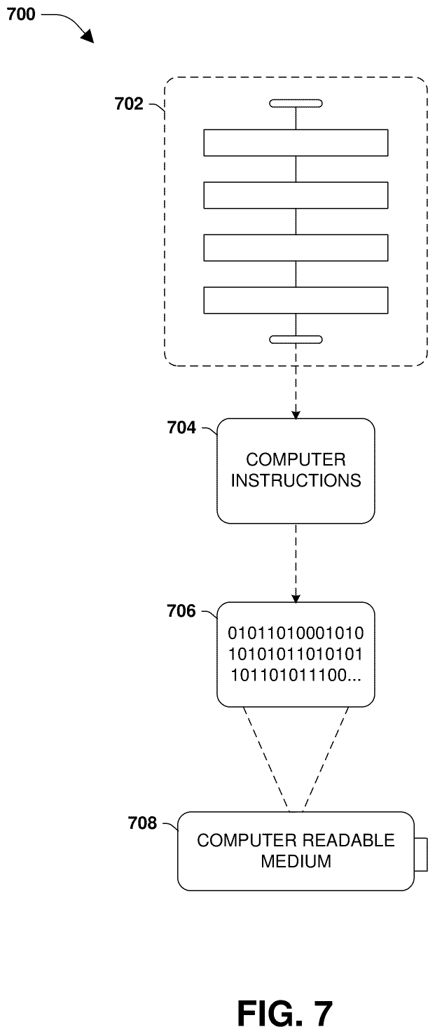

Still another embodiment involves a computer-readable medium 700 comprising processor-executable instructions configured to implement one or more of the techniques presented herein. An example embodiment of a computer-readable medium or a computer-readable device that is devised in these ways is illustrated in FIG. 7, wherein the implementation comprises a computer-readable medium 708, such as a compact disc-recordable (CD-R), a digital versatile disc-recordable (DVD-R), flash drive, a platter of a hard disk drive, etc., on which is encoded computer-readable data 706. This computer-readable data 706, such as binary data comprising at least one of a zero or a one, in turn comprises processor-executable computer instructions 704 configured to operate according to one or more of the principles set forth herein. In some embodiments, the processor-executable computer instructions 704 are configured to perform a method 702 such as the methods of FIGS. 2A, 2B, and 4A. In some embodiments, the processor-executable computer instructions 704 are configured to implement a system such as system 100 of FIG. 1, system 300 of FIGS. 3A-3D, system 450 of FIG. 4B, and/or system 500 of FIG. 5. Many such computer-readable media are contemplated to operate in accordance with the techniques presented herein.

In an embodiment, the described methods and/or their equivalents may be implemented with computer executable instructions. Thus, in an embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (Saas) architecture, a smart phone, and so on. In an embodiment, a computing device is implemented with one or more executable algorithms that are configured to perform any of the disclosed methods.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), electrically erasable programmable read-only memory (EEPROM) and/or flash memory, compact disk read only memory (CD-ROM) s, CD-Rs, compact disk re-writeable (CD-RW) s, DVDs, cassettes, magnetic tape, magnetic disk storage, optical or non-optical data storage devices and/or any other medium which can be used to store data.

Some examples of the claimed subject matter have been described with reference to the drawings, where like reference numerals are generally used to refer to like elements throughout. In the description, for purposes of explanation, numerous specific details are set forth in order to provide an understanding of the claimed subject matter. It may be evident, however, that the claimed subject matter may be practiced without these specific details. Nothing in this detailed description is admitted as prior art.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard application or engineering techniques to produce software, firmware, hardware, or any combination thereof to control a computer to implement the disclosed subject matter. The term “article of manufacture” as used herein is intended to encompass a computer application accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, an application, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as indicators, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In some embodiments, a method is provided. The method includes tagging a data set with an indicator to indicate that the data set is to be protected by an allocation area protection group; evaluating the data to identify data sets tagged with the indicator for transferring the data from a memory to a storage device; in response to identifying the data set as being tagged with the indicator and the allocation area protection group does not exist, selecting a plurality of allocation areas, each selected allocation area from a different Redundant Array of Independent Disks (RAID) array, to form the allocation area protection group for storing the data set; and updating an allocation area ownership map to indicate that the plurality of selected allocation areas form the allocation area protection group into which the data set is stored.

In some embodiments, wherein storage shelves contain RAID arrays and wherein each selected allocation area of the allocation area protection group is selected from a different storage shelf of the storage shelves. In some embodiments, a first selected allocation area of the allocation area protection group is selected from a first storage shelf of the storage shelves and a second selected allocation area of the allocation area protection group is selected from a second storage self of the storage shelves.

In some embodiments, the method in response to identifying data of a first data set not tagged with the indicator, transferring the data of the first data set from the memory into one or more allocation areas of a RAID array, wherein the one or more allocation areas are not used by allocation area protection groups.

In some embodiments, the method includes designating an allocation area of the plurality of selected allocation areas as being a parity bearing allocation area and remaining allocation areas of the plurality of selected allocation areas as being data bearing allocation areas.

In some embodiments, the method includes allocating a new block from one of the data bearing allocation areas; storing data of the data set into the new block; and updating the parity bearing allocation area based upon the data being stored into the new block.

In some embodiments, the method includes in response to a failure affecting a data bearing allocation area of the allocation area protection group, transitioning into a degraded mode where degraded read operations are executed upon operational data bearing allocation areas and a parity bearing allocation area of the allocation area protection group used for reconstructing data contained on the data bearing allocation area.

In some embodiments, the method includes in response to a recovery procedure being initiated for a failed RAID array, selecting a model from a set of available models for the recovery procedure based upon model selection rules, wherein a first model is used to directly exit a degraded mode, and wherein a second model performs post processing for the storage before exiting the degraded mode; and utilizing the model as part of the recovery procedure.

In some embodiments, the method includes initiating a recovery procedure for a failed RAID array, wherein the allocation area protection group is rebuilt to exit from a degraded mode.

In some embodiments, the method includes initiating a recovery procedure for a failed RAID array, wherein the recovery procedure includes: deconstructing the allocation area protection group; creating a new allocation area protection group; and creating a new allocation area ownership map to map blocks of the allocation area ownership map to blocks of the new allocation area ownership map.

In some embodiments, a computing device is provided. The computing device includes a memory storing instructions and a processor coupled to the memory, the processor configured to execute the instructions to perform operations. The operations include tagging a data set with an indicator to indicate that the data set is to be protected by an allocation area protection group; evaluating the data to identify data sets tagged with the indicator for transferring the data from a memory to a storage device; in response to identifying the data set as being tagged with the indicator and the allocation area protection group does not exist, selecting a plurality of allocation areas, each selected allocation area from a different Redundant Array of Independent Disks (RAID) array, to form the allocation area protection group for storing the data set; and updating an allocation area ownership map to indicate that the plurality of selected allocation areas form the allocation area protection group into which the data set is stored.

In some embodiments, the operations include designating an allocation area of the plurality of selected allocation areas as being a parity bearing allocation area; and in response to detecting corrupt metadata, utilizing the parity bearing allocation area to reconstruct the metadata.

In some embodiments, the operations include selecting a number of allocation areas as the plurality of selected allocation areas based upon an efficiency metric.

In some embodiments, the operations include selecting one allocation area from each RAID array for inclusion within the plurality of selected allocation areas formed as the allocation area protection group.

In some embodiments, the operations include in response to a recovery procedure being initiated for a failed RAID array, selecting a model from a set of available models for the recovery procedure based upon model selection rules, wherein a first model is used to exit a degraded mode, and wherein a second model performs post processing for the storage before exiting the degraded mode; and utilizing the model as part of the recovery procedure.

In some embodiments, the operations include designating an allocation area of the plurality of selected allocation areas as being a parity bearing allocation area and remaining allocation areas of the plurality of selected allocation areas as being data bearing allocation areas.

In some embodiments, the operations include allocating a new block from one of the data bearing allocation areas; storing data of the data set into the new block; and updating the parity bearing allocation area based upon the data being stored into the new block.

In some embodiments, non-transitory machine readable medium is provided. The non-transitory machine readable medium comprises instructions for performing a method, which when executed by a machine, causes the machine to perform operations. The operations include tagging a data set with an indicator to indicate that the data set is to be protected by an allocation area protection group; evaluating the data to identify data sets tagged with the indicator for transferring the data from a memory to a storage device; in response to identifying the data set as being tagged with the indicator and the allocation area protection group does not exist, selecting a plurality of allocation areas, each selected allocation area from a different Redundant Array of Independent Disks (RAID) array, to form the allocation area protection group for storing the data set; and updating an allocation area ownership map to indicate that the plurality of selected allocation areas form the allocation area protection group into which the data set is stored.

In some embodiments, storage shelves contain RAID arrays and wherein the allocation area protection groups containing the selected allocation areas are each in different storage shelves.

In some embodiments, the operations include designating an allocation area of the plurality of selected allocation areas as being a parity bearing allocation area and remaining allocation areas of the plurality of selected allocation areas as being data bearing allocation areas.

In some embodiments, the data set is protected by both the allocation area protection group and RAID protection based upon the data set being tagged with the indicator, and wherein data sets not tagged with the indicator are protected by the RAID protection but not by allocation area protection groups.

What is claimed is:

1. A method, comprising:
tagging a data set with an indicator to indicate that the data set is to be protected by an allocation area protection group;
evaluating the data to identify data sets tagged with the indicator for transferring the data from a memory to a storage device;
in response to identifying the data set as being tagged with the indicator and the allocation area protection group does not exist, selecting a plurality of allocation areas, each selected allocation area from a different Redundant Array of Independent Disks (RAID) array, to form the allocation area protection group for storing the data set; and
updating an allocation area ownership map to indicate that the plurality of selected allocation areas form the allocation area protection group into which the data set is stored.

2. The method of claim 1, wherein a first selected allocation area of the allocation area protection group is selected from a first storage shelf and a second selected allocation area of the allocation area protection group is selected from a second storage self.

3. The method of claim 1, comprising:
in response to identifying data of a first data set not tagged with the indicator, transferring the data of the first data set from the memory into one or more allocation areas of a RAID array, wherein the one or more allocation areas are not used by allocation area protection groups.

4. The method of claim 1, comprising:
designating an allocation area of the plurality of selected allocation areas as being a parity bearing allocation area and remaining allocation areas of the plurality of selected allocation areas as being data bearing allocation areas.

5. The method of claim 4, comprising:
allocating a new block from one of the data bearing allocation areas;
storing data of the data set into the new block; and
updating the parity bearing allocation area based upon the data being stored into the new block.

6. The method of claim 1, comprising:
in response to a failure affecting a data bearing allocation area of the allocation area protection group, transitioning into a degraded mode where degraded read operations are executed upon operational data bearing allocation areas and a parity bearing allocation area of the allocation area protection group used for reconstructing data contained on the data bearing allocation area.

7. The method of claim 1, comprising:
in response to a recovery procedure being initiated for a failed RAID array, selecting a model from a set of available models for the recovery procedure based upon model selection rules, wherein a first model is used to directly exit a degraded mode, and wherein a second model performs post processing for the storage before exiting the degraded mode; and
utilizing the model as part of the recovery procedure.

8. The method of claim 1, comprising:
initiating a recovery procedure for a failed RAID array, wherein the allocation area protection group is rebuilt to exit from a degraded mode.

9. The method of claim 1, comprising:
initiating a recovery procedure for a failed RAID array, wherein the recovery procedure includes:
deconstructing the allocation area protection group;
creating a new allocation area protection group; and
creating a new allocation area ownership map to map blocks of the allocation area ownership map to blocks of the new allocation area ownership map.

10. A computing device comprising:
a memory storing instructions; and
a processor coupled to the memory, the processor configured to execute the instructions to perform operations comprising:
tagging a data set with an indicator to indicate that the data set is to be protected by an allocation area protection group;
evaluating the data to identify data sets tagged with the indicator for transferring the data from the memory to a storage device;
in response to identifying the data set as being tagged with the indicator and the allocation area protection group does not exist, selecting a plurality of allocation areas, each selected allocation area from a different Redundant Array of Independent Disks (RAID) array, to form the allocation area protection group for storing the data set; and
updating an allocation area ownership map to indicate that the plurality of selected allocation areas form the allocation area protection group into which the data set is stored.

11. The computing device of claim 10, wherein the operations comprise:
designating an allocation area of the plurality of selected allocation areas as being a parity bearing allocation area; and
in response to detecting corrupt metadata, utilizing the parity bearing allocation area to reconstruct the metadata.

12. The computing device of claim 10, wherein the operations comprise:
selecting a number of allocation areas as the plurality of selected allocation areas based upon an efficiency metric.

13. The computing device of claim 10, wherein the operations comprise:
selecting one allocation area from each RAID array for inclusion within the plurality of selected allocation areas formed as the allocation area protection group.

14. The computing device of claim 10, wherein the operations comprise:
in response to a recovery procedure being initiated for a failed RAID array, selecting a model from a set of available models for the recovery procedure based upon model selection rules, wherein a first model is used to exit a degraded mode, and wherein a second model performs post processing for the storage before exiting the degraded mode; and
utilizing the model as part of the recovery procedure.

15. The computing device of claim 10, wherein the operations comprise:
designating an allocation area of the plurality of selected allocation areas as being a parity bearing allocation area and remaining allocation areas of the plurality of selected allocation areas as being data bearing allocation areas.

16. The computing device of claim 15, wherein the operations comprise:
allocating a new block from one of the data bearing allocation areas;
storing data of the data set into the new block; and
updating the parity bearing allocation area based upon the data being stored into the new block.

17. A non-transitory machine readable medium comprising instructions for performing a method, which when executed by a machine, causes the machine to perform operations comprising:
tagging a data set with an indicator to indicate that the data set is to be protected by an allocation area protection group;
evaluating the data to identify data sets tagged with the indicator for transferring the data from a memory to a storage device;
in response to identifying the data set as being tagged with the indicator and the allocation area protection group does not exist, selecting a plurality of allocation areas, each selected allocation area from a different Redundant Array of Independent Disks (RAID) array, to form the allocation area protection group for storing the data set; and
updating an allocation area ownership map to indicate that the plurality of selected allocation areas form the allocation area protection group into which the data set is stored.

18. The non-transitory machine readable medium of claim 17, wherein storage shelves contain RAID arrays and wherein the allocation area protection groups containing the selected allocation areas are each in different storage shelves.

19. The non-transitory machine readable medium of claim 17, wherein the operations comprise:
designating an allocation area of the plurality of selected allocation areas as being a parity bearing allocation area and remaining allocation areas of the plurality of selected allocation areas as being data bearing allocation areas.

20. The non-transitory machine readable medium of claim 17, wherein the data set is protected by both the allocation area protection group and RAID protection based upon the data set being tagged with the indicator, and wherein data sets not tagged with the indicator are protected by the RAID protection but not by allocation area protection groups.
